(19) United States
(12) Patent Application Publication
(10) Pub. No.: US 2017/0189768 A1
(43) Pub. Date: Jul. 6, 2017

(54) TOY FOOTBALL WITH WIRELESS CONNECTIVITY

(71) Applicant: Performance Designed Products LLC, Burbank, CA (US)

(72) Inventor: Christopher K. Dingle, Los Angeles, CA (US)

(73) Assignee: Performance Designed Products LLC, Burbank, CA (US)

(21) Appl. No.: 14/987,525

(22) Filed: Jan. 4, 2016

(51) Int. Cl. A63B 43/00; H04L 29/08; H04B 7/26; A63B 24/00; A63B 71/06

(52) U.S. Cl. CPC A63B 43/004; A63B 24/0006; A63B 71/0605; H04B 7/26; H04L 67/12

(57) ABSTRACT

A wireless-speaker includes an audio playback module mounted in an interior portion of a housing; a sensor package mounted in the interior portion of the housing, and including an accelerometer to detect motion of the wireless speaker and to generate sensor data corresponding to the detected motion; and a wireless communication transceiver configured to receive audio content from an external device over a wireless communication channel for playback by the audio module, and to receive sensor data from the sensor package for transmission to the external device.

### TECHNICAL FIELD

The disclosed technology relates generally to wireless entertainment apparatus, and more particularly, some embodiments relate to a football or other projectile with wireless connectivity for features such as gameplay and audio playback.

### DESCRIPTION OF THE RELATED ART

Wireless audio loudspeakers have become commonplace in a variety of environments. Wireless speakers connect to an amplifier via electromagnetic energy (e.g. radiofrequency (RF) communications) instead of via audio cables or speaker wire. Wireless speakers have achieved tremendous popularity in recent years due to their portability and relative ease of use and placement.

The communication channels or protocols used by wireless speakers have included channels in the cordless telephone band (e.g., around 900 MHz) and more recently have been implemented using Bluetooth® connectivity.

### BRIEF SUMMARY OF EMBODIMENTS

According to various embodiments of the disclosed technology, a wireless audio speaker, which can include a single speaker or two or more speakers, is provided. The wireless audio speaker can be packaged in a prolate spheroid, or football-shaped package to form a wireless-speaker football. Bluetooth or Wi-Fi connectivity can be provided to allow the wireless audio speaker to communicate with other devices such as audio players and other audio sources. Such audio sources can include, for example, MP3 players, smart phones, tablets, computers and computing systems, smart TVs, audio receivers, gaming devices and gaming consoles, and so on. Connectivity to audio sources can be provided to allow audio content from these sources to be played back over the wireless audio speaker via the wireless communication interface. For example, where Bluetooth or other like connectivity is provided, these audio sources can transmit audio content via the wireless interface to the wireless audio speaker for playback. As another example, where Wi-Fi or like connectivity is provided, the audio sources can be configured to transmit audio content through a Wi-Fi router to the wireless audio speaker. Two-way communications can be provided to allow control of the audio sources (other user interface to the audio sources) via a keypad, touch screen or other input devices on the wireless speaker.

The wireless audio speaker can also be configured to wirelessly communicate with other devices (such as those listed above) for gameplay or other activity whether in conjunction with or independent of audio playback. Accordingly, the wireless audio speaker can include one or more sensors, processors, data storage, and other capabilities to allow data to be captured, communicated, and processed on board, for gameplay activities. To better illustrate this aspect of the technology, consider it in the context of an example where the wireless audio speaker is packaged in the shape of a football. In this example, the wireless-speaker football can further include one or more accelerometers to detect the motion of the wireless-speaker football as it is thrown by or among various users or players. The flight dynamics of the football can be sensed by the accelerometers, and communicated to an external device to be tallied or otherwise evaluated for gameplay purposes. The external device can include, for example, a processing device such as a smart phone, tablet, computing device, etc. A game application may be running on the external device to evaluate the throw based on accelerometer data, score the throw based on the data, tally game scores, store game data and so on.

According to an embodiment of the disclosed technology, a wireless speaker includes a housing defining an interior portion and an exterior portion, the housing comprising a plurality of ports; an audio playback module mounted in the interior portion of the housing and comprising an audio amplifier and an audio speaker; a sensor package mounted in the interior portion of the housing, the sensor package comprising an accelerometer to detect motion of the wireless speaker and to generate sensor data corresponding to the detected motion; and a wireless communication transceiver comprising a first input configured to receive audio content from an external device over a wireless communication channel for playback by the audio module, and a second input coupled to receive sensor data from the sensor package.

The housing can be configured to include a foam material to provide some level of impact resistance. In some embodiments, the housing can comprise a rigid or semi-rigid housing, and in further embodiments, a foam outer shell can be disposed on this rigid or semirigid housing.

In still further embodiments a football game system can be provided and can include a wireless football speaker and a gaming device in communicative contact with one another. The wireless football speaker can include: a housing configured as a prolate spheroid and defining an interior portion and an exterior portion, the housing comprising a plurality of ports; an audio amplifier mounted in the interior portion of the housing; an audio speaker mounted in the interior portion of the housing electrically coupled to the amplifier; a sensor package mounted in the interior portion of the housing, the sensor package comprising an accelerometer to detect motion of the football in flight and to generate sensor data corresponding to the detected motion of the football; and a first wireless communication transceiver comprising a first input configured to receive audio content from an external gaming device over a wireless communication channel and a first output coupled to the audio amplifier to send the audio content to the audio amplifier for playback using the audio speaker, and a second input coupled to receive sensor data from the sensor package.

The gaming device can be configured to include a second wireless transceiver and a processing device, the processing device may include a processor and a non-transitive storage medium with computer program code stored thereon configured to cause the processing device to perform the operations of: synchronizing the gaming device with the football to allow the gaming device to communicate with the football; initializing a game; sending gameplay instructions to the football via the first and second wireless transceivers; receiving sensor data from the football via the first and second wireless transceivers; and determining game scoring data based on the sensor data.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

Some of the figures included herein illustrate various embodiments of the disclosed technology from different viewing angles. Although the accompanying descriptive text may refer to such views as “top,” “bottom” or “side” views, such references are merely descriptive and do not imply or require that the disclosed technology be implemented or used in a particular spatial orientation unless explicitly stated otherwise.

FIG. 1 is a diagram illustrating an example wireless-speaker football in accordance with one embodiment of the technology described herein.

FIG. 2 is a diagram illustrating an end-on view of the example wireless speaker 102 illustrated in FIG. 1.

FIG. 3 is a diagram illustrating a rear view of the example wireless speaker illustrated in FIG. 1.

FIG. 4A is a diagram illustrating a top-down, plan view of the example wireless speaker 102 illustrated in FIG. 1.

FIG. 4B is a diagram illustrating a perspective view of the example wireless speaker 102 illustrated in FIG. 1.

FIGS. 5 and 6 are additional diagrams illustrating embodiments of a wireless speaker 102 configured in the shape of a football.

FIG. 7 is a diagram illustrating an exploded view of an example wireless speaker in accordance with one embodiment of the technology disclosed herein.

FIG. 8 is a diagram illustrating an exploded view of another example embodiment of a wireless speaker shaped like a football.

FIG. 9 is a diagram illustrating an example process for pairing an operating a wireless speaker (such as a wireless-speaker football) with an external device in accordance with one embodiment of the technology described herein.

FIG. 10 is a diagram illustrating an example process for gameplay in accordance with one embodiment of the technology disclosed herein.

FIG. 11 is a diagram illustrating an example of internal electronics for wireless speaker 102 in accordance with one embodiment of the technology disclosed herein.

FIG. 12 illustrates an example computing module that may be used in implementing various features of embodiments of the disclosed technology.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Embodiments of the technology disclosed herein are directed toward systems and methods for providing a wireless audio loudspeaker. In various embodiments, a wireless audio speaker, which can include a single speaker or two or more speakers, can be provided in the shape of a football or other gaming implement.

Embodiments of the technology disclosed herein provide a toy football apparatus with one or more internal speakers and an audio amplifier. The internal speakers in this and other embodiments may be paired with or synced to an external device via wireless connectivity, such as Bluetooth, Wi-Fi, WiMAX, other IEEE 802.xx networks, or other wireless communication channel or protocol. The toy football (or other wireless speaker) can further include an internal accelerometer to sense motion so that acceleration and deceleration of the apparatus along or about one or more axes can be determined.

The device that is synced to or paired with the wireless speaker may be configured to provide audio to and receive data from the wireless speaker via the wireless interface. This device may be a stationary or a mobile device and may include, for example, MP3 players, smart phones, tablets, computers and computing systems, smart TVs, audio receivers, and so on.

A gaming or educational application, local or cloud based, may be run on the device to allow game play in conjunction with the wireless speaker device. In the example in which the wireless speaker is packaged as a football or other game-friendly apparatus, games can be included with the external device that receive and use data collected by the internal accelerometer in the toy football. The games can analyze the data, measure performance based on accelerometer or other sensor data, generate scores based on performance, provide feedback to the user and so on. Feedback provided can be audio feedback through the one or more audio speakers or tactile feedback provided by haptic feedback device included in the wireless speaker.

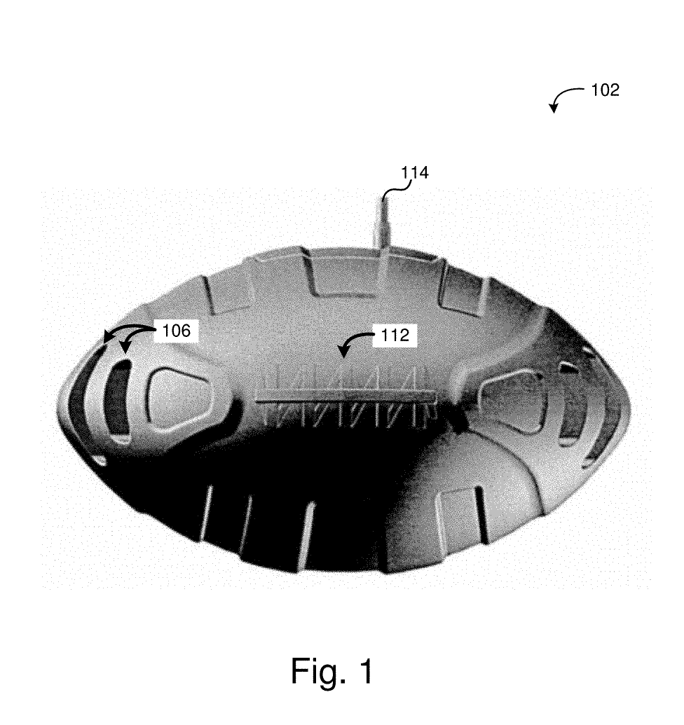

FIG. 1 is a diagram illustrating an example wireless-speaker football in accordance with one embodiment of the technology described herein. In the example illustrated in FIG. 1, the wireless speaker 102 is configured in the overall shape of a football. The overall shape of wireless speaker 102 is in the form of a prolate spheroid or spindle-shaped ellipsoid, having a polar radius greater than its equatorial radius resulting in a somewhat pointed shape. As seen in the example of FIG. 1, this wireless speaker 102 is characterized by two pointed ends. As also seen in the example of FIG. 1, wireless speaker 102 also includes, in some embodiments, ports 106 which are openings to allow one or more audio speakers mounted behind the ports 106 to emanate sound.

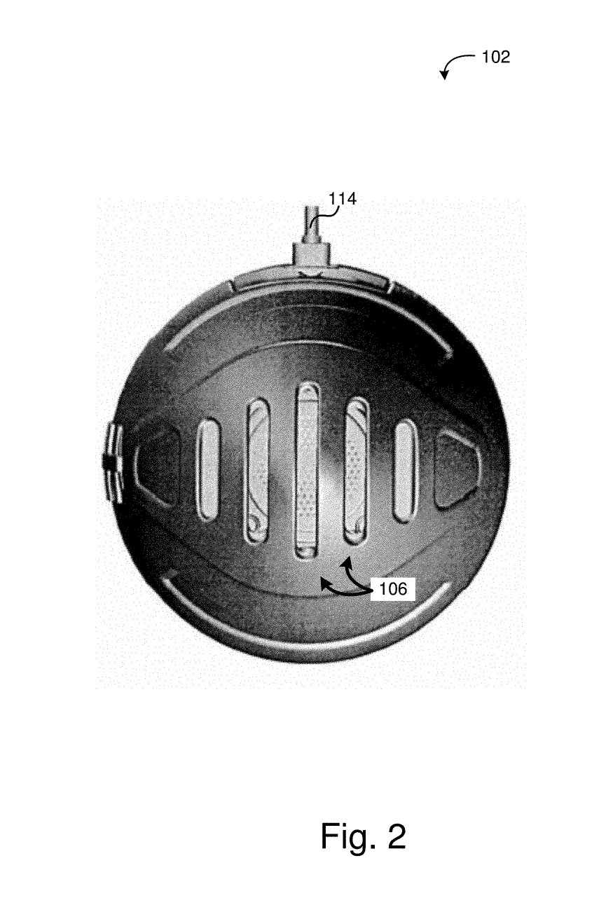

FIG. 2 is a diagram illustrating an end-on view of the example wireless speaker 102 illustrated in FIG. 1. In this example, an audio speaker is shown as being mounted behind ports 106. More particularly, a grill of the audio speaker is visible through the ports 106 in this drawing. Although one round speaker is illustrated, one of ordinary skill in the art reading this description will appreciate that multiple speakers can be mounted behind port 106, the one or more speakers can have shapes other than round (e.g., oval, elliptical, rectangular, and so on), and one or more speakers can incorporate multiple drivers to handle different frequency ranges (e.g., two-way, three-way, and so on).

Referring back to FIG. 1, the illustrated example includes a pattern in the shape of places that can be embossed, molded, or otherwise disposed on the surface of the wireless speaker 102. This lace pattern can be used to further suggest that the wireless speaker 102 is embodied as a football. The example illustrated in FIG. 1 further includes a power/sync button 114, which in this example is illustrated as extending beyond the body of the wireless speaker 102. In various embodiments, button 114 can be configured as retractable so it can be made to be flush with the exterior contour of the body of wireless speaker 102. In other embodiments, power/sync buttons can be configured as flush with or recessed (to avoid accidental actuation) the exterior contour of the body.

The outer body of wireless speaker in this and other embodiments can be made from any of a number of different materials, including natural, synthetic or semi-synthetic materials (e.g., organics) that can be molded, cast, or otherwise formed into the desired shape. Practical examples for implementations involving gameplay can include plastics and other polymers including sponge-like and other foam materials, while other examples can further include wood, glass, ceramics, or any of a number of different materials.

In some implementations, the outer body can be a relatively hard, rigid or semi-rigid molded or cast piece that is formed into the desired shape and that is sufficiently rigid to maintain the desired shape during use and normal intended handling. This piece can be coated with rubber, foam, polystyrene, leather, fabric, or other material of desired texture or softness. For example, some embodiments include a rigid or semi-rigid plastic shell coated with a cellular polyurethane or other foam material to provide cushioning of the device. Such implementations may be desirable for wireless speakers intended for gameplay as they can generally be tossed with less risk of damage or injury due to the soft outer shell. In other embodiments, the foam-like material can be dense enough or rigid enough to maintain the desired shape of the implement and provide support for internal components such that a rigid or semi-rigid internal shell is not needed to support and maintain the overall shape.

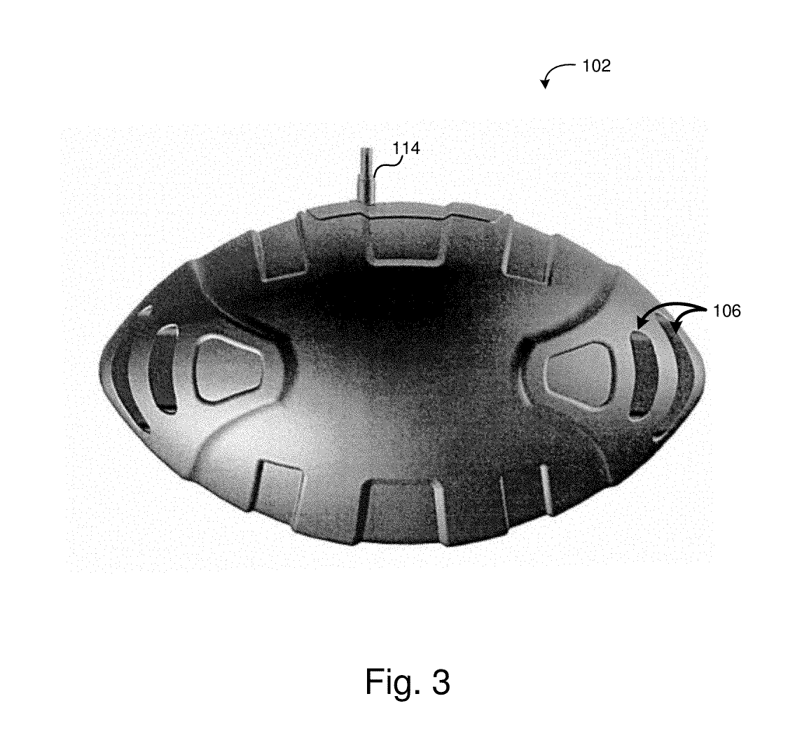

FIG. 3 is a diagram illustrating a rear view of the example wireless speaker 102 illustrated in FIG. 1. In the illustrated example, there is no lace pattern on the back side of wireless speaker 102. As shown, ports 106 are also included on the back side of wireless speaker 102 in this example to allow sound to emanate in a rearward as well as a forward direction.

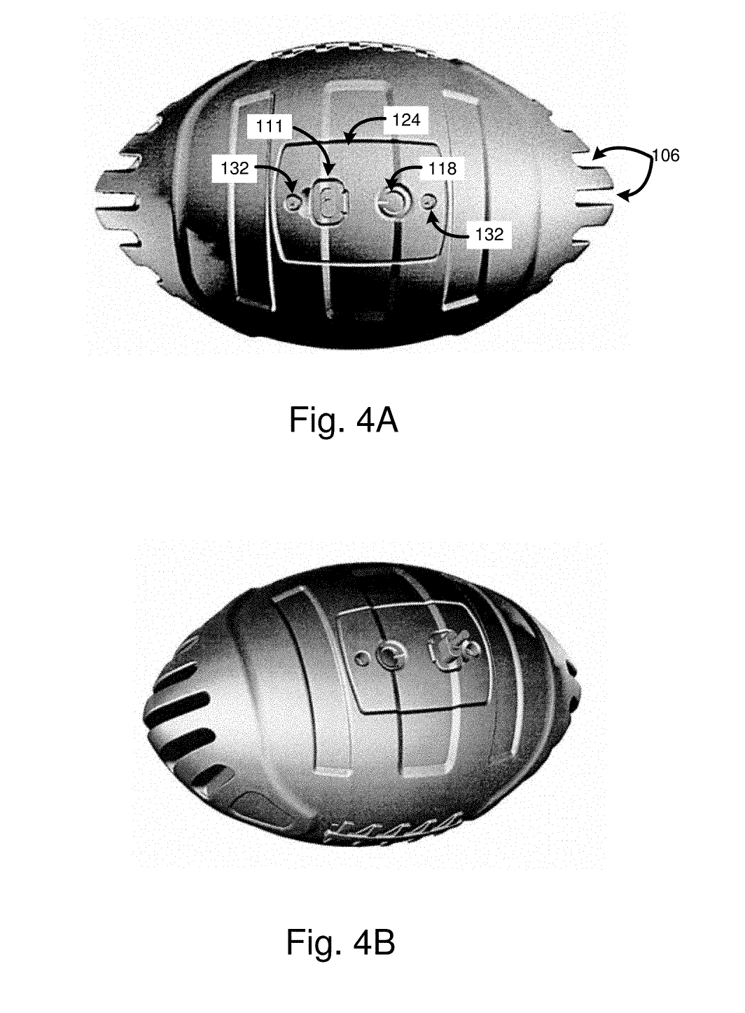

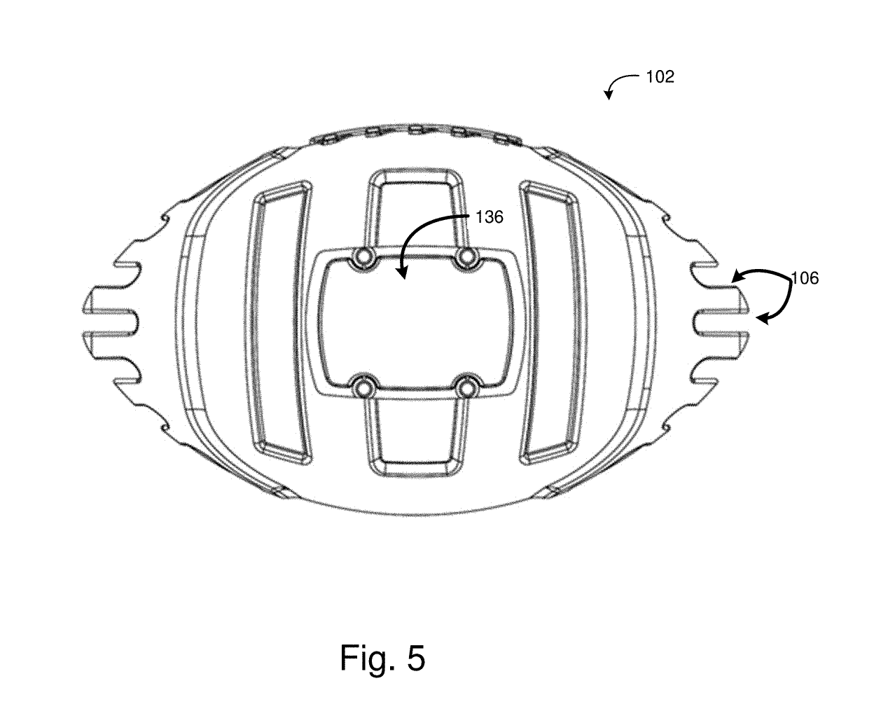

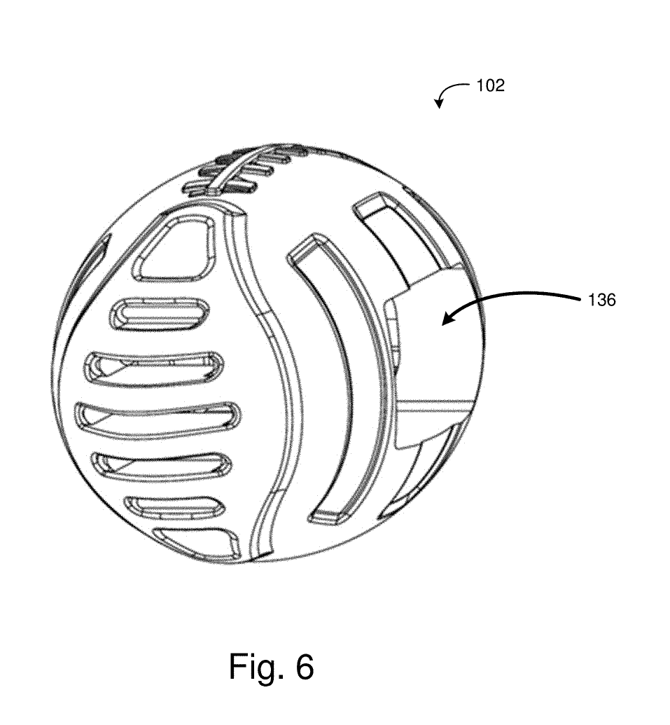

FIG. 4 comprises FIGS. 4A and 4B. FIG. 4A is a diagram illustrating a top-down, plan view of the example wireless speaker 102 illustrated in FIG. 1. FIG. 4B is a diagram illustrating a perspective view of the example wireless speaker 102 illustrated in FIG. 1. In the example illustrated in FIG. 4, the wireless speaker 102 includes a power switch 118, and access port (element 136 illustrated in FIGS. 5 and six) covered by access cover 124 and fasteners 132 to fasten access cover to the main body portion of wireless speaker 102.

Fasteners 132 can include, for example, screws, bolts or other thread fasteners; rivets; clips; snap tabs or other removable fasteners to allow access cover 124 to be removably mounted to the body of wireless speaker 102. In still further embodiments, access cover 124 can be secured to the body of wireless speaker 102 using welds, glue, solvents, or other like securing mechanisms.

In various embodiments, power switch 118 can be used to power wireless speaker 102 on and off. Power switch 118 can also be configured as a multifunctional switch to allow other operations such as, for example, wireless network syncing or pairing, volume control, and so on. Power switch 118 can include a visual indicator to indicate the state of the device (e.g., on or off). The visual indicator can include, for example, a single or multi color LED or other light source that can be controlled or actuated by a processor or other circuitry within the wireless speaker to provide an indication of state to the user.

Although not illustrated in the embodiment of FIG. 4, in various embodiments additional switches or other user interface elements can be included to allow the user to provide input, or receive output from the wireless speaker. For example, a keypad, a touchscreen display, additional buttons or switches, or other user input devices can be included to accept user input. Likewise, a display (whether touchscreen or otherwise), indicator lights, haptic feedback mechanisms, or other devices can be used to provide information or output to the user.

As the example of FIGS. 1-4 also illustrate, ports 106 can extended a sufficient amount in length and depth such that the ports are not only open toward the ends of the football, but are also open toward the top and bottom of the football. This can allow for audio to emanate in more of an omnidirectional manner.

FIGS. 5 and 6 are additional diagrams illustrating embodiments of a wireless speaker 102 configured in the shape of a football. FIG. 5 illustrates a top-down view of an example wireless speaker configured as a football in accordance with one embodiment of the technology described herein. FIG. 6 illustrates a perspective view of an example wireless speaker configured as a football in accordance with one embodiment of the technology described herein. The example embodiment illustrated in FIGS. 5 and 6 show opening 136 that can be included to provide access to internal components of wireless speaker 102. Opening 136 can be dimensioned to allow internal components such as speakers, accelerometers, power supplies, communication devices and so on to be placed and mounted internally to wireless speaker 102.

The surface features such as the lace pattern, indentations, ports, and so on, differ slightly from the examples illustrated in FIGS. 1-4. As these examples serve to illustrate, the wireless speaker 102 can be configured with a number of different patterns or surface features. In various embodiments, the outer surface of the wireless speaker 102 (whether in the shape of a football or other shape) can alternatively have a smooth or relatively smooth outer surface.

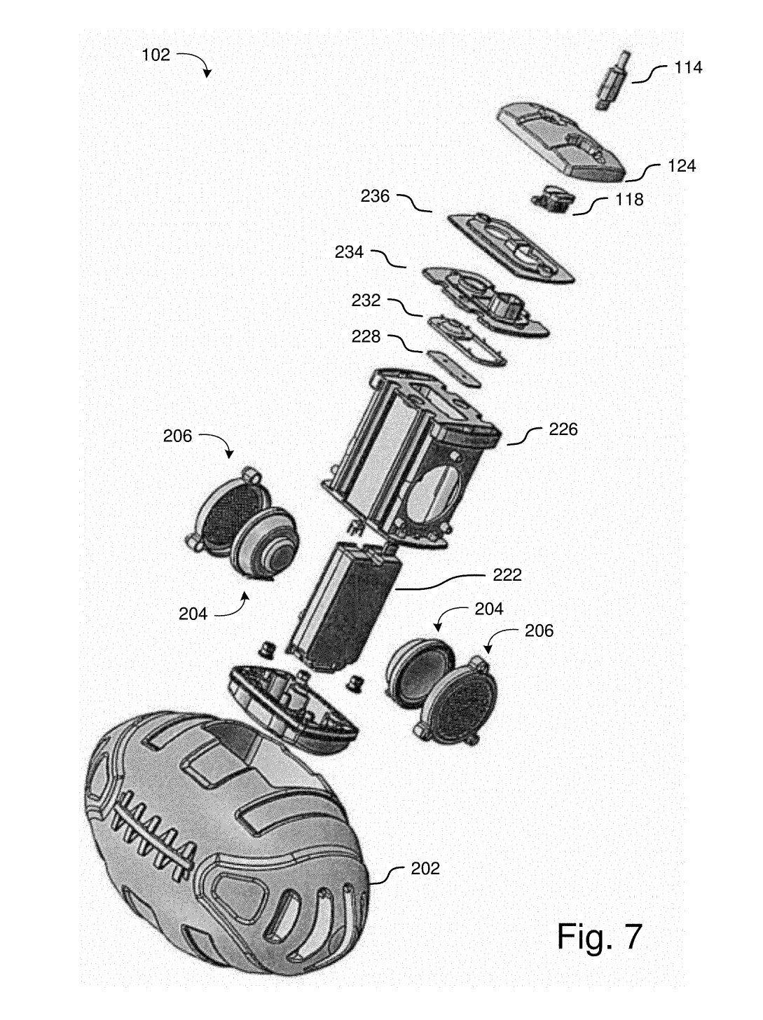

FIG. 7 is a diagram illustrating an exploded view of an example wireless speaker in accordance with one embodiment of the technology disclosed herein. In this example, wireless speaker 102 includes a molded body 202 with a number of components configured to be mounted within the molded body 202. In this example, these components include two speakers 204, speaker grills 206, electronic componentry 222, speaker and electronics housing 226, battery contact mount 228, battery contact components 232, battery compartment which may include an internal battery 234, battery compartment cover 236, power switch 118 and access cover 124.

Speakers 204 can comprise weather resistant, impact-proof speakers mounted within housing 226. Grills 206 can be provided to help protect speakers 204 from physical damage.

Electronic componentry 222 can include components such as a Bluetooth radio, a Wi-Fi radio, other communications interfaces, an audio amplifier (e.g., monaural, stereo, or multi-channel), and computing or logic circuitry to control operation of the device. Examples of computing or logic circuitry can include a processing device, an ASIC, an FPGA, discrete logic circuitry, and so on. In some embodiments, wireless speaker 102 is configured with a limited set of electronic circuitry sufficient to sink with an external device, receive audio from the external device, and playback the received audio through the speakers. Accordingly, such embodiments may include the communications interface and an audio amplifier to allow wireless audio functionality. In other embodiments, wireless speaker 102 may be configured with a more robust set of electronic circuitry to include not only the communications interface and audio amplifier, but may also include sensors such as, for example, accelerometers or other motion sensors; sensor interfaces to receive data or other sensitive information from the sensors; computing or logic circuitry; and so on.

Electronic componentry 222 can be mounted in a weather resistant housing, and as noted above, speakers 204 can also be weather resistant, to allow outdoor use of wireless speaker 102.

Housing 226 can be a single unit (e.g. cast, molded, etc.) or can be an assembly of components configured to form the housing. In the illustrated example, speakers 204 are mounted in apertures in housing 226 and grills 206 are mounted on the housing over the audio speakers 204.

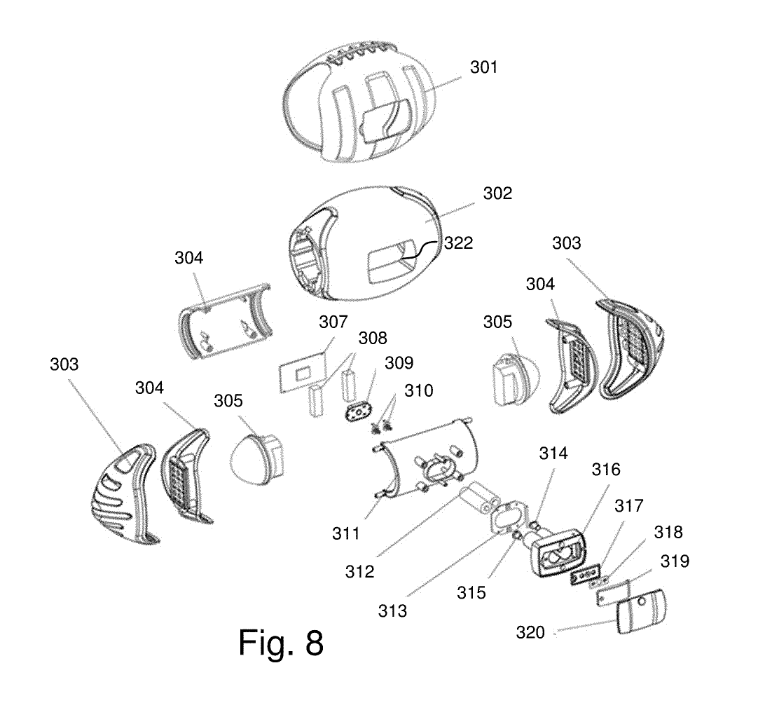

FIG. 8 is a diagram illustrating an exploded view of another example embodiment of a wireless speaker shaped like a football. The example illustrated in FIG. 8 includes a separate body portion 302 and outer shell 301, speaker caps 304 and end caps 303. In this example, the outer casing or outer shell 301 is separate from body portion 302 and end caps 303 are separable as well. In some embodiments, outer shell 301 and end caps 303 can be made of a foam or other sponge-like material to provide a relatively soft outer surface (e.g., rubber, foam, polystyrene, leather, fabric, or other material of desired texture or softness) while body portion 302 and speaker caps 304 can be made of a more rigid molded or cast piece that is formed into and maintains the desired shape.

This example further includes a two-piece housing 306, 311 to house electronic components. These electronics in this example include a printed circuit board 307, energy source 312, and associated electrical interconnections. Although not illustrated, accelerometers can also be mounted within the housing such as, for example on printed circuit board 307. The two halves of the housing 306, 311 can be configured to be snapped, glued, screwed, or otherwise fastened together once the components are properly assembled therein. Speakers 305 are configured to be mounted in openings on either end of the assembled housing 306, 311. As with other embodiments, speakers 305 can be weatherproof and impact proof, and embodiments can include other quantities of speakers. This example further illustrates speaker ports in end caps 303 to allow the passage of audio from the speakers 305. Similarly, speaker caps 304 include a grill to also allow acoustic energy to pass from speakers 305. The grill can also provide protection from physical impact to the speaker cones or domes.

Energy source 312 can include, for example, batteries (rechargeable or non-rechargeable), or other sources of portable power. Component mounts 309, 314, and 315 can provide support for energy source 312 and other components as well. Printed circuit board 313 can be included to provide an electrical interface between energy source 312 and other electrical components in the system. A battery compartment 316 can be used to house the batteries (or other energy source 312), and this example further includes a battery contact mount 317, battery contacts 318 and a battery compartment door 319 to provide closure for compartment 316 and hold the batteries in place and in contact with the corresponding electrical contacts. Battery compartment 316 and battery compartment door 319 can be configured to provide a weatherproof housing for the batteries or other energy source 312 contained therein. Accordingly, the appropriate environmental seals can be included around door 319 or at other seams or joints in the housing.

Outer body cover 320 can be used to cover the opening 322 through which access to energy source 312 can be provided. Outer body cover 320 can be made of the same material as outer shell 301. Outer body cover 320 can include environmental seals to prevent or otherwise minimize the intrusion of moisture into the inside of the enclosure.

In the illustrated example, access to some of the components such as energy source 312 can be achieved through opening 322. This can allow, for example, replacement or recharging of the energy source 312. Also in this example, components internal to the housing 306, 311 can be mounted on either or both halves of the housing 306, 311 prior to assembly of the housing and mounting of the housing inside body portion 302. The housing can be sized to fit within either or both openings at the ends of body portion 302 for assembly.

Although not illustrated, haptic feedback devices can be included with the wireless speaker to provide tactile feedback to a user. Various vibratory devices can be used to provide this feedback such as, for example, eccentric rotating mass vibration motors, linear resonant actuators, and so on.

Also included in this example are mounts 308, component mount 309 and screws 310 used to mount electrical components of the wireless speaker.

Although the examples depicted herein are shown and described as being configured in the shape of a football, in other embodiments, the wireless speaker can be packaged in other shapes. For example, the wireless speaker can be configured as another form of ball such as, for example, a basketball, bowling ball, soccer ball, or other projectile; a sports implement such as a golf club, tennis racket, etc.; or any of a number of other devices or implements. As still further examples, the wireless speaker can be configured as a peripheral such as a gaming controller, mouse, joystick, or other input device.

Further features of the wireless speaker can include an internal weather resistant and impact-proof housing for the speakers, electrical components, and power source. The design or configuration of other components of the system can further be configured to provide some level of impact resistance for the wireless speaker. For example, as noted above, the housing can be made of or clad with a polyurethane foam or other foam-like or sponge-like material to receive and dissipate energy upon impact. Likewise, the speaker ports, or the end caps in general, can be configured to flex thereby also dissipating impact energy. Speaker grills or other speaker enclosure structures (e.g. elements 304 and 305 in FIG. 8) can also be configured to be flexible to dissipate impact. Additionally, impact-absorbing (e.g. flexible or spring-like) mounts can be used to mount the speakers to their corresponding housings. Similarly, other impact-absorbing materials can be used to further receive and dissipate the energy of impact.

Accelerometers as described herein can be implemented utilizing any of a number of different sensing devices to detect acceleration or deceleration in one or more directions. In various embodiments, piezoelectric, piezoresistive and capacitive components, for example, may be used to convert mechanical motion of the wireless speaker into an electrical signal reflecting changes in motion or direction. As one example, a one- two- or three-axis accelerometer can be used to measure static and dynamic acceleration. As another example, a three-axis accelerometer and three-axis gyroscope with an associated processor can be used to compute 6- or 9-axis motion of the implement during use.

As noted, the wireless speaker in accordance with various embodiments can further be configured to facilitate gameplay among one or more gaming participants. Sensors such as accelerometers or other input devices can be used to receive gaming input and provide this gaming data to a game application for processing for gameplay. As noted above, accelerometers can be used to determine the attributes of flight or movement of the wireless speaker. This can include, for example, flight attributes of a wireless-speaker football, basketball, or other moving object; the movement of an implement such as the swinging of a bat, tennis racket or golf club; the movement of a gaming controller, and so on.

Consider further the example of a wireless-speaker ball (e.g., a football) that is either thrown, hit or kicked by a game player. Accelerometers and other sensors can be used to detect roll, pitch and yaw characteristics of the wireless-speaker football in flight as well as acceleration and deceleration. Position determination system such as, for example, a GPS receiver, can be used to determine velocity, flightpath, flight distance, and so on. Information from sensors such as these can be used to generate gaming scoring data to score an event such as a throw or a kick based on the flight characteristics. This can include, for example, determining who through the football farther, who through it faster, who through a smooth or spiral pass, whose throw was more on target, and so on. This information can also be used for training purposes to identify areas that can be improved in a player's throw or kick.

Although any of a number of games can be configured to be played with the wireless speaker, a few examples are now described. These examples are described in terms of embodiments of a wireless speaker configured as a football. In the first example a player powers on the wireless-speaker football and activates the corresponding game application on the electronic device. When the game is ready, the player throws the toy football to another player. During flight, sensors in the football detect the flight characteristics, and this flight information is collected and provided to the gaming app for evaluation. The toy football can be configured to provide an audio queue from the internal speakers while in flight. The player is scored based on the flight attributes, and the score may be tallied on the gaming app as well as announced or displayed on the wireless-speaker football. In addition to flight attributes, the sensors can be used to detect whether the toy football was caught by another player or whether it was missed or dropped, based on accelerometer data at and around the point of impact.

As another example, a hot potato game scenario can be provided where the toy football prompts the player (e.g. via an audio or haptic queue) to throw the football to another player after holding the football for a determined period of time. The accelerometers are other sensors can be used to detect whether the ball was actually thrown and whether was caught. Position determination and/or flight path information can be used to determine to whom the ball was thrown and who has it to throw next. Sensor information can also be used to determine whether the ball was dropped or caught. As with the first example, the application can be configured to compute scoring information as well as to compute flight information based on the sensor data. In various embodiments, a more computationally robust version of the football (or other wireless speaker implementation) can be configured with the necessary processing power to compute flight information or scoring information, or both, itself without relying on the gaming application for these computations.

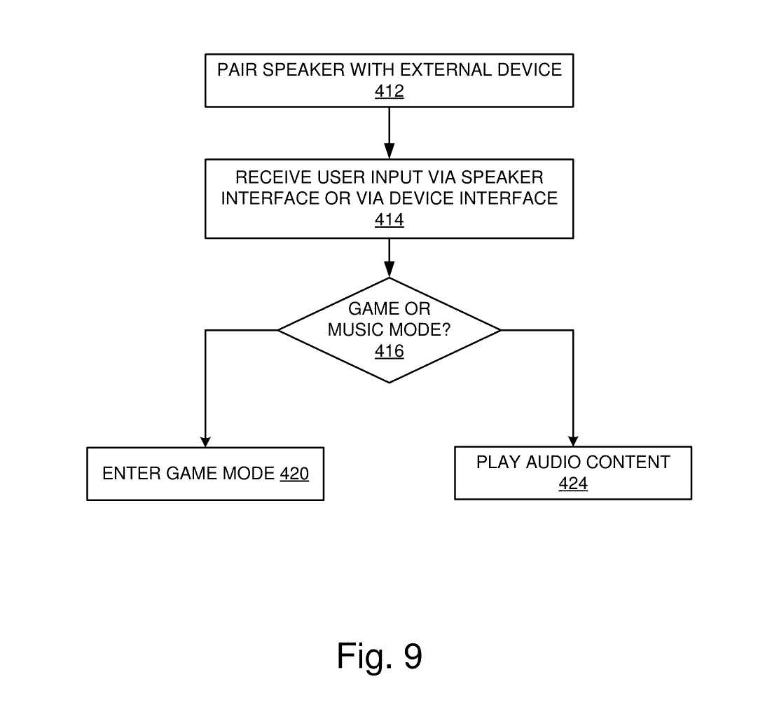

FIG. 9 is a diagram illustrating an example process for pairing an operating a wireless speaker (such as a wireless-speaker football) with an external device in accordance with one embodiment of the technology described herein. In this example, at operation 412 a user pairs the speaker with the external device. This operation can involve, for example, following a sync process to connect the wireless speaker with the external device. This can be, for example, a Bluetooth pairing process or a network registration process. Buttons or other user interface devices on the wireless speaker can be included to facilitate this pairing.

At operation 414, the application receives user input. The user input can include input indicating intended use for the wireless speaker. For example, the user may have the opportunity to choose between a music mode or a game mode. In a music mode, the wireless speaker may be used to play music from an MP3 player or other external device. In a game mode, the wireless speaker may be configured for gameplay such as for the example games described above. In other embodiments, a combined game and music mode can be included such that music can be played by the wireless speaker during gameplay.

In some embodiments, the application can be an app running on an external device such as, for example, a gaming app on a mobile device. User input can be made via the external device itself such as via a touchscreen display. In some embodiments, user input can also be made via a user interface on the wireless speaker itself. As also noted above, in other embodiments, the application can be an application running on an application platform internal to the wireless speaker.

At operation 416, the application determines whether the device is in the game mode or the music mode. Based on this determination, the application enters the game mode 420 or the playback mode 424 as appropriate.

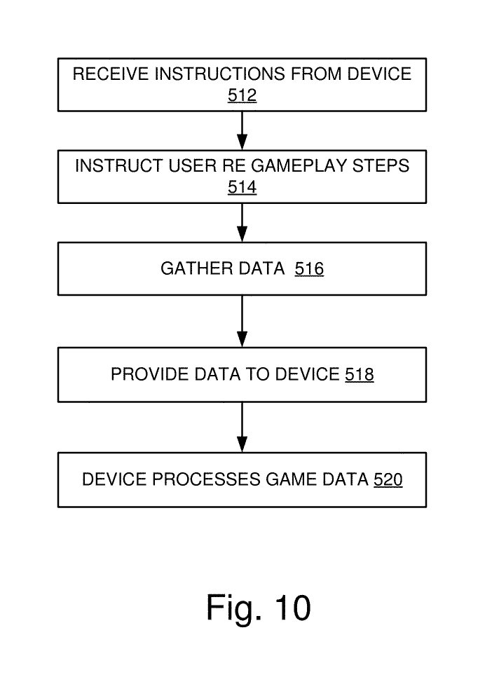

FIG. 10 is a diagram illustrating an example process for gameplay in accordance with one embodiment of the technology disclosed herein. In this example, the wireless speaker receives instructions from the application such as an application running on an external device. This is illustrated at operation 512.

At operation 514, instructions are provided to the user or users regarding gameplay steps. These instructions can be provided by the electronic device running the application or from the wireless speaker itself through audio or visual cues. For example, in terms of the hot potato game, the wireless-speaker ball can provide a haptic or an audio queue instructing the user to throw the ball at the determined time. As another example in a throwing game, the wireless-speaker ball can instruct the user to throw a short pass, through a long pass, punt the ball, and so on.

At operation 516, sensors such as accelerometers, GPS receivers, and so on gather data regarding motion of the wireless speaker. As noted in the examples above, this can include flight characteristics information, impact information, direction, and so on. This data can be gathered and stored on board or it can be communicated in real time wirelessly to the application running on the external device. This is illustrated at operation 518. At operation 520 the sensor data is processed and scoring, training feedback or other information can be provided.

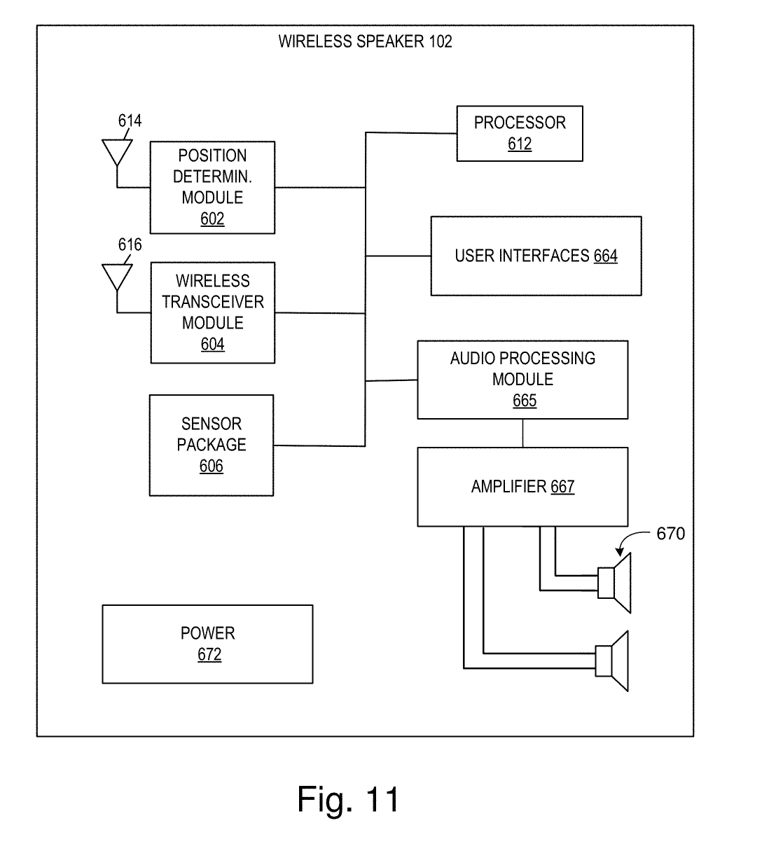

FIG. 11 is a diagram illustrating an example of internal electronics for wireless speaker 102 in accordance with one embodiment of the technology disclosed herein. This example includes a wireless transceiver module 604 and associated antenna 616 which can include, for example, a Bluetooth modem, a Wi-Fi transceiver or one or more other wireless communications interfaces.

Sensor package 606 can include sensors described above such as, for example, accelerometers and other sensors. A position determination module 602 and associated antenna 614 can be included to provide position determination of the wireless speaker 102. Examples of a position determination module can include, for example, a GPS receiver and position location system.

In embodiments where additional intelligence is provided with wireless speaker 102, processing module 612 can be included for functions such as, for example, sensor data processing, position determination, audio generation, or other functions. Such a processing module 612 can include one or more processors and memory to perform the desired processing functions.

User interfaces 664 can be provided to allow user operation of the wireless speaker 102 and to allow wireless speaker 102 to provide information to the user. As noted above, in various embodiments user interfaces 664 can be relatively simple buttons or switches, while in other embodiments more sophisticated user interfaces such as touchscreen displays can also be provided.

This example also includes an audio amplifier 667 and a pair of audio speaker 670. An audio processing module 665 such as, for example, an audio processing DSP can also be included to provide audio processing. In some embodiments, an off-the-shelf Bluetooth module or other like module can provide the wireless transceiver and audio playback functions necessary for straightforward audio playback by wireless speaker 102.

Finally, one or more power devices can also be included to provide energy to the wireless speaker. A power or energy source 672 can include, for example, one or more rechargeable batteries, Faraday devices (e.g., devices that convert kinetic energy or motion to electrical energy) capacitive storage devices, photovoltaic cells, and so on.

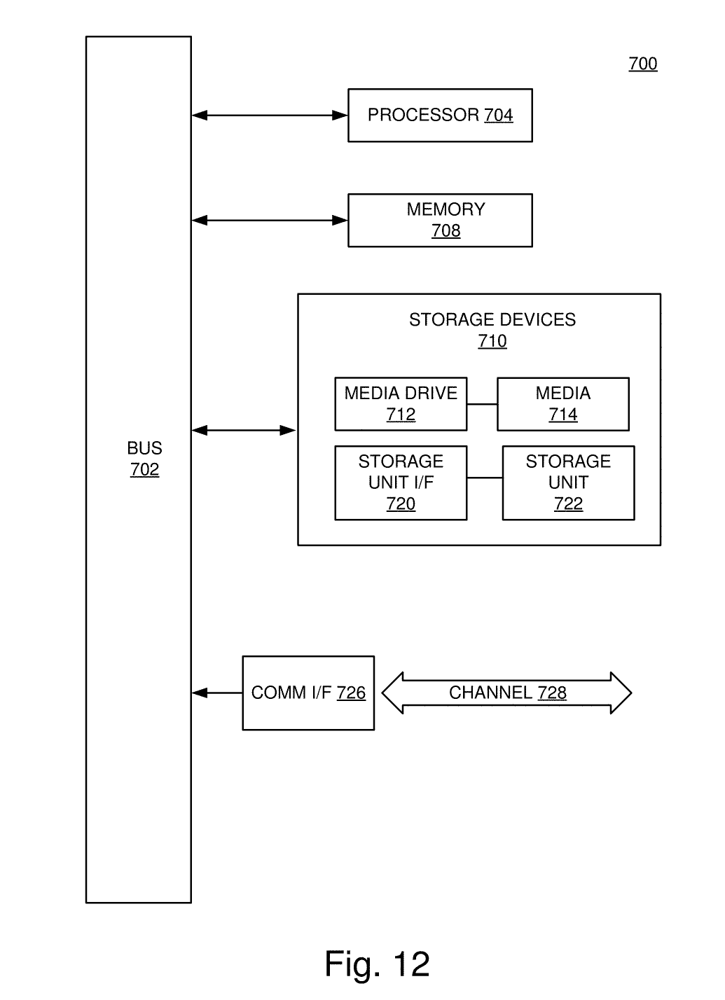

As used herein, the term module might describe a given unit of functionality that can be performed in accordance with one or more embodiments of the technology disclosed herein. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the technology are implemented in whole or in part using software, in one embodiment, these software elements can be implemented to operate with a computing or processing module capable of carrying out the functionality described with respect thereto. One such example computing module is shown in FIG. 12. Various embodiments are described in terms of this example—computing module 700. After reading this description, it will become apparent to a person skilled in the relevant art how to implement the technology using other computing modules or architectures.

Referring now to FIG. 12, computing module 700 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 700 might also represent computing capabilities embedded within or otherwise available to a given device.

Computing module 700 might include, for example, one or more processors, controllers, control modules, or other processing devices, such as a processor 704. Processor 704 might be implemented using a general-purpose or special-purpose processing engine such as, for example, a microprocessor, controller, or other control logic. In the illustrated example, processor 704 is connected to a bus 702, although any communication medium can be used to facilitate interaction with other components of computing module 700 or to communicate externally.

Computing module 700 might also include one or more memory modules, simply referred to herein as main memory 708. For example, preferably random access memory (RAM) or other dynamic memory, might be used for storing information and instructions to be executed by processor 704. Main memory 708 might also be used for storing temporary variables or other intermediate information during execution of instructions to be executed by processor 704. Computing module 700 might likewise include a read only memory (“ROM”) or other static storage device coupled to bus 702 for storing static information and instructions for processor 704.

The computing module 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a floppy disk drive, a magnetic tape drive, an optical disk drive, a CD or DVD drive (R or RW), or other removable or fixed media drive might be provided. Accordingly, storage media 714 might include, for example, a hard disk, a floppy disk, magnetic tape, cartridge, optical disk, a CD or DVD, or other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing module 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory module) and memory slot, a PCMCIA slot and card, and other fixed or removable storage units 722 and interfaces 720 that allow software and data to be transferred from the storage unit 722 to computing module 700.

Computing module 700 might also include a communications interface 724. Communications interface 724 might be used to allow software and data to be transferred between computing module 700 and external devices. Examples of communications interface 724 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 724 might typically be carried on signals, which can be electronic, electromagnetic (which includes optical) or other signals capable of being exchanged by a given communications interface 724. These signals might be provided to communications interface 724 via a channel 728. This channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 708, storage unit 720, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 700 to perform features or functions of the disclosed technology as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A ball game system, comprising:
a ball, comprising:
a housing configured as a spheroid and defining an interior portion and an exterior portion, the housing comprising a plurality of ports;
an audio amplifier mounted in the interior portion of the housing;
an audio speaker mounted in the interior portion of the housing electrically coupled to the amplifier;
a sensor package mounted in the interior portion of the housing, the sensor package comprising an accelerometer to detect motion of the ball and to generate sensor data corresponding to the detected motion of the ball;
a first wireless communication transceiver comprising a first input configured to receive audio content from an external gaming device over a wireless communication channel and a first output coupled to the audio amplifier to send the audio content to the audio amplifier for playback using the audio speaker, and a second input coupled to receive sensor data from the sensor package; and
the gaming device, comprising a second wireless transceiver and a processing device, the processing device comprising a processor and a non-transitory storage medium with computer program code stored thereon configured to cause the processing device to perform the operations of:
synchronize the gaming device with the ball to allow the gaming device to communicate with the ball;
initialize a game;
send gameplay instructions to the ball via the first and second wireless transceivers;
receive sensor data from the ball via the first and second wireless transceivers; and
determine game scoring data based on the sensor data.

2. The ball game system of claim 1, further comprising a position determination system to generate position information of the ball and to send position information to the gaming device via the first and second wireless transceivers.

3. The ball game system of claim 1, wherein the accelerometer comprises a three-axis accelerometer to measure static and dynamic acceleration.

4. The ball game system of claim 1, wherein the accelerometer comprises a three-axis accelerometer and a three-axis gyroscope.

5. The ball game system of claim 4, wherein the computer program code is further configured to compute 6- or 9-axis motion of the ball during gameplay.

6. The ball game system of claim 1, wherein the housing is a rigid or semi-rigid housing.

7. The ball game system of claim 6, further comprising a foam outer shell disposed on the housing.

8. The ball game system of claim 1, wherein determining scoring based on sensor data comprises determining movement characteristics of the ball for a first event by a first player based on the sensor data and calculating a score based on the determined movement characteristics.

9. The ball game system of claim 19, wherein determining scoring based on sensor data comprises determining flight characteristics of the football for a first event by a first player based on the sensor data and calculating a score based on the determined flight characteristics.

10. A wireless speaker, comprising:
a housing defining an interior portion and an exterior portion, the housing comprising a plurality of ports;
an audio playback module mounted in the interior portion of the housing and comprising an audio amplifier and an audio speaker;
a sensor package mounted in the interior portion of the housing, the sensor package comprising an accelerometer to detect motion of the wireless speaker and to generate sensor data corresponding to the detected motion; and
a wireless communication transceiver comprising a first input configured to receive audio content from an external device over a wireless communication channel for playback by the audio module, and a second input coupled to receive sensor data from the sensor package.

11. The wireless speaker of claim 10, wherein the housing is configured in the shape of a prolate spheroid.

12. The wireless speaker of claim 10, wherein the housing comprises a foam material.

13. The wireless speaker of claim 10, further comprising a position determination system to generate position information of the wireless speaker.

14. The wireless speaker of claim 10, wherein the accelerometer comprises a three-axis accelerometer to measure static and dynamic acceleration.

15. The wireless speaker of claim 10, wherein the accelerometer comprises a three-axis accelerometer and a three-axis gyroscope.

16. The wireless speaker of claim 10, wherein the housing is a rigid or semi-rigid housing.

17. The wireless speaker of claim 16, further comprising a foam outer shell disposed on the housing.

18. The wireless speaker of claim 10, wherein the housing is configured in the shape of a ball or a gaming implement.

19. The ball game system of claim 1, wherein the ball is a football, and wherein the housing is configured as a prolate spheroid.
